(19) United States
(12) Patent Application Publication
(10) Pub. No.: US 2019/0220065 A1
(43) Pub. Date: Jul. 18, 2019

(54) FASTENERS UTILIZED WITHIN AN ENCLOSURE FOR AN ELECTRONIC DEVICE

(71) Applicant: Apple Inc., Cupertino, CA (US)

(72) Inventors: Simon Regis Louis LANCASTER-LAROCQUE, San Jose, CA (US); Kent JOHNSTON, Lake Oswego, OR (US); Michael MALONEY, Doylestown, PA (US); John C. DIFONZO, Emerald Hills, CA (US); Gurshan DEOL, Santa Clara, CA (US); Kamal H. HABBOUB, Tampa, FL (US); Keith J. HENDREN, San Francisco, CA (US); Karan BIR, Cupertino, CA (US); Steven J. OSBORNE, San Jose, CA (US); Christiaan A. LIGTENBERG, San Carlos, CA (US)

(21) Appl. No.: 16/248,704

(22) Filed: Jan. 15, 2019

Related U.S. Application Data
(60) Provisional application No. 62/728,553, filed on Sep. 7, 2018.
(60) Provisional application No. 62/617,547, filed on Jan. 15, 2018.

(51) Int. Cl. G06F 1/16; F16B 21/20; H01F 7/02

(52) U.S. Cl. CPC G06F 1/1679; F16B 21/20; G06F 1/1616; G06F 1/1662; H01F 7/0252; G06F 1/1681

(57) ABSTRACT

This application relates to hidden fasteners within an electronic device. An electronic device can include a top portion and a base portion that includes a housing and a cover attached to the housing by at least one fastener that is not visible through an external surface of the cover. Each fastener includes a receiver housing that retrains spherical components and a pin that can be inserted into an opening in the receiver housing. The pin is retained in the receiver housing by a force imparted against a surface of the pin by the spherical components, which are biased towards an inner surface of the receiver housing sloped towards the opening. The pin can be released when an external magnetic field from a magnet placed proximate the bottom surface of the receiver housing retracts the spherical components away from the opening, thereby reducing the force against the surface of the pin.

### CROSS-REFERENCE TO RELATED APPLICATIONS

The present application claims the benefit of U.S. Provisional Application No. 62/617,547, entitled “ENCLOSURE WITH MAGNETIC RELEASE FASTENER,” filed Jan. 15, 2018, the content of which is incorporated herein by reference in its entirety for all purposes. The present application also claims the benefit of U.S. Provisional Application No. 62/728,553, entitled “FASTENERS UTILIZED WITHIN AN ENCLOSURE FOR AN ELECTRONIC DEVICE,” filed Sep. 7, 2018, the content of which is incorporated herein by reference in its entirety for all purposes.

### FIELD

The described embodiments relate generally to mechanical fasteners. More particularly, the present embodiments relate to utilizing a mechanical fastener to secure components of a housing of an electronic device in a manner in which the fastener is not visible on an exterior surface of the electronic device.

### BACKGROUND

Electronic devices, such as mobile phones, laptop computers, tablet computers, or displays, typically include a housing that secures a number of operational components such as printed circuit boards, integrated circuit packages, batteries, solid state drives, and the like within a cavity of the housing. The housing can include multiple structural components that are secured by various means, typically including at least one or more screws or other mechanical fasteners that are visible on an external surface of the housing. For example, a base portion of a laptop computer can include a bottom cover that is secured to a main component of the base portion via a number of screws. The heads of the screws can be visible on a bottom surface of the laptop computer. Sometimes, these screws are hidden by securing rubbing feet or other cosmetic and functional devices over the screws in an effort to hide how the bottom cover is secured to the main component of the base portion.

As an alternate to screws, another solution for securing housing components together is to use adhesive to secure two components together. However, utilizing an adhesive in this manner does not permit easy disassembly and re-assembly of the device for servicing parts or components within the device. Consequently, most solutions merely attempt to minimize the number of mechanical fasteners that are visible on an exterior surface of the device.

### SUMMARY

This paper describes various embodiments that relate to fasteners. The fasteners are utilized in an electronic device such as a mobile phone, laptop computer, tablet computer, or display device to hide the mechanical fasteners used to secure components together from an exterior vantage point. In some embodiments, the fasteners can be utilized to secure a cover to an aluminum housing of a base portion of a laptop computer. Once secure, the cover can be removed utilizing magnetic elements placed proximate the fastener, which releases a pin inserted into an opening of a receiver housing of the fastener thereby allowing the cover to be removed from the aluminum housing.

In some embodiments, a portable electronic device is disclosed that includes a base portion including a keyboard and a top portion including a display. The base portion is attached to the top portion via a hinge. The portable electronic device includes a housing of the base portion that has a cavity formed therein. Operational components of the portable electronic device are disposed in the cavity and attached to the housing. A cover is secured to the housing via a fastener to enclose the cavity. The fastener includes a receiver housing having a surface that includes an opening, spherical components enclosed within the receiver housing, and a pin configured to be inserted into the opening such that the spherical components are in contact with the pin and an inner surface of the receiver housing that is sloped toward the opening. The spherical components are biased toward the opening in the surface of the receiver housing by a spring. Therefore, what is desired is a means to secure components together that is hidden through an exterior surface of the device.

In some embodiments, the opening in the receiver housing is chamfered to aid in guiding the pin into the opening. In other embodiments, the tip of the pin is chamfered to aid in guiding the pin into the opening. In yet other embodiments, at least one of the receiver housing or the pin is floating in a separate housing with respect to the housing or the cover.

In some instances, the design of a device may be more appealing, aesthetically, if a surface of the device is not interrupted by holes for mechanical fasteners. For example, an intent of the designer may be to make a housing appear to be a continuous unitary body unencumbered by holes for fasteners or other functional structures. Accordingly, in some embodiments, the fastener is enclosed within the cavity when the cover is attached to the housing and not visible through an external surface of the cover. In some embodiments, a first portion of each fastener is attached to an internal surface of the housing and a second portion of each fastener is attached to an internal surface of the cover. In some embodiments, the cover is secured to the housing via at least two fasteners.

In some embodiments, the spring is a wave spring. In other embodiments, the spring is a coil spring. In yet other embodiments, the spring is a stack of Belleville washers. The number of Belleville washers can be one or more.

In some embodiments, the portable electronic device is a laptop computer that includes a top portion and a base portion. The base portion includes a keyboard and other operational components of the laptop computer. The top portion includes a display and is coupled to the base portion via a hinge. The base portion of the laptop computer includes an aluminum housing, a cover that overlays an opening in the aluminum housing that leads to a cavity, and a fastener that secures the cover to the aluminum housing. Each fastener includes a structure and a pin. The structure has a first surface that includes an opening and a second surface attached to the aluminum housing. The pin has a size and shape suitable to be inserted into the opening of the structure. In some embodiments, the pin includes a flange attached to the cover. The pin is retained within the structure by a force applied to a surface of the pin by spherical components retained within the structure and arranged to contact the surface of the pin and an inner surface of the structure sloped towards the opening.

In some embodiments, the laptop computer includes operational components disposed in the cavity of the housing such as a memory that stores instructions and a processor in communication with the memory and configured to execute the instructions. The operational components of the laptop computer disposed in the cavity of the aluminum housing can also include a printed circuit board, a trackpad, audio transducers (e.g., speakers), a radio frequency transceiver, and an energy storage device.

In some embodiments, the spherical components are ferromagnetic such that, under an influence of a magnetic field generated by a magnetic element placed proximate a side of the fastener opposite the opening in the surface of the receiver housing relative to the spherical components, the spherical components experience an attractive force due to the magnetic field that is directed away from the opening in the surface of the receiver housing.

In other embodiments, the force is based on an interference between a spherical component and a detent feature located on the pin, the spherical component held against the detent feature by a ferromagnetic release mechanism biased toward the top surface of the structure. In some embodiments, the spherical component is retained within a hole formed in a bearing holder at a distance D from the bottom surface of the structure.

In some embodiments, an apparatus is disclosed that includes a housing for a keyboard. The apparatus includes a first component of the housing that defines a cavity, a second component of the housing configured to be secured to the first component, a pin attached to a surface of either the first component or the second component, and a receiver housing attached to a surface of either the second component or the first component such that the pin and the receiver housing are attached to different components of the first component and the second component. The receiver housing includes an opening for accepting the pin, the opening having a diameter that is greater than a diameter of the pin. The receiver housing retains spherical components biased against a sloped surface of the receiver housing and a surface of the pin when the pin is inserted into the opening.

In some embodiments, the receiver housing retains three spherical components configured to surround the pin. In other embodiments, the receiver housing retains four or more spherical components configured to surround the pin. In some embodiments, the spherical components are retained within a bearing holder configured to equally space the spherical components around a perimeter of the pin. In some embodiments, a diameter of the spherical components and/or the pin is approximately one millimeter.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a computing device, in accordance with the prior art.

FIG. 2 shows a bottom view of the base portion of the computing device, in accordance with the prior art.

FIGS. 3A-3C illustrate a fastener, in accordance with some embodiments.

FIGS. 4A-4C illustrate a fastener utilized to secure an enclosure of a computing device, in accordance with some embodiments.

FIGS. 5A-5B illustrate the base portion of the computing device incorporating the fastener, in accordance with some embodiments.

FIG. 6A illustrates a partial cross sectional view of a fastener, in accordance with some embodiments.

FIG. 6B illustrates the holder of FIG. 6A, in accordance with some embodiments.

FIG. 6C illustrates a cross sectional view of an alternate embodiment of a fastener, with a magnetic field generator integrated with the fastener, in accordance with some described embodiments.

FIG. 7A-7B illustrates a means for attaching a pin to a wall of a component, in accordance with some embodiments.

FIG. 8 illustrates a fastener, in accordance with some embodiments.

FIG. 9 illustrates a fastener, in accordance with some embodiments.

FIG. 10 illustrates a fastener, in accordance with some embodiments.

FIG. 11 illustrates a fixture used to access a cavity within the computing device of FIG. 4A, in accordance with some embodiments.

FIG. 12 shows the fixture of FIG. 11 utilized to open the enclosure of a base portion of the computing device, in accordance with some embodiments.

FIG. 13 illustrates a display device, in accordance with some embodiments.

FIG. 14 shows a rear view of the display device, in accordance with some embodiments.

FIG. 15 illustrates a flowchart of an exemplary method to access an enclosure of a computing device secured with fasteners, in accordance with some embodiments.

FIG. 16 illustrates a detailed view of an exemplary computing device that can be used to implement the various apparatus and/or methods described herein, in accordance with some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting, such that other embodiments may be used, and changes may be made without departing from the spirit and scope of the described embodiments.

Industrial design can incorporate a particular aesthetic to certain devices that dictates the use of hidden fasteners. Traditionally, fasteners can be hidden under certain features such as rubber feet located on the bottom surface of a device. However, these designs limit where fasteners can be located without moving the location of the rubber feet. A better design can utilize fasteners that can be operated using remote means, such as a magnetic field, to release the fasteners.

In some embodiments, a fastener is described that can be incorporated into the design of an electronic device such as a laptop computer. The fastener can include a receiver housing and a pin. The receiver housing may include a top surface with an opening formed therein that accepts insertion of the pin. The receiver housing can also enclose a number of spherical components and a spring for biasing the spherical components against an inner surface of the receiver housing that is sloped toward the top surface. The spherical components are free to move towards a bottom surface of the receiver housing when the pin is inserted into the opening. However, the spherical components will wedge against the inner surface and the surface of the pin when the pin is being extracted, thereby imparting a large normal force against the surface of the pin. This normal force impedes the extraction of the pin based on friction, thereby locking the pin in place. A magnetic field can be utilized to pull the spherical components away from the sloped surface to enable the pin to be extracted from the opening.

The fasteners can be included in a laptop computer, such as between a housing and a cover for a base portion of the laptop computer. The base portion of the laptop computer can include multiple fasteners disposed therein. The fasteners can also be incorporated into other portable computing devices such as tablet computers or mobile phones. Furthermore, the fasteners can be incorporated into less portable devices such as display devices, televisions, and the like.

The fasteners can use a variety of means for biasing the spherical components against the sloped surface of the receiver housing. For example, the spring may include a conventional coil spring, a stack of Belleville washers, a wave spring, or a leaf spring. The spherical components can also be enclosed loosely within the receiver housing, optionally resting on a washer. Alternatively, the spherical components can be enclosed within a holder configured to restrain the freedom of the spherical components to keep the spherical components in a planar arrangement equally spaced around the pin. The number of spherical components retained within the receiver housing can be three or more.

The fasteners can be miniaturized to fit within the small confined spaces in many portable device enclosures. For example, a fastener can be approximately 5 millimeters (“mm”) in height and less than 5 mm in diameter, including a flange of the receiver housing for attaching the receiver housing to a surface of a component via adhesive or welding. The spherical components and pin can be approximately 1 mm in diameter. The frictional force imparted on the pin when the spherical components are wedged against the sloped surface of the receiver housing can be on the order of hundreds of Newtons.

These fasteners enable tamper resistant features to be implemented within the enclosure of a computing device. A fixture including multiple magnets may be required to separate the components, which prevents the enclosure from being accessed with common tools. In addition, the location and/or polarity of the magnets in the fixture can be adjusted to implement some form of identifier-based tamper resistance that requires knowledge of how the fasteners are configured within the device to access the enclosure of the device. While these tamper resistant measures are not unbreakable, they create barriers to a person that is attempting to open the device.

It should also be noted that the fasteners described herein (in contrast to conventional adhesives) can facilitate disassembly rendering the electronic device more amenable to being recycled.

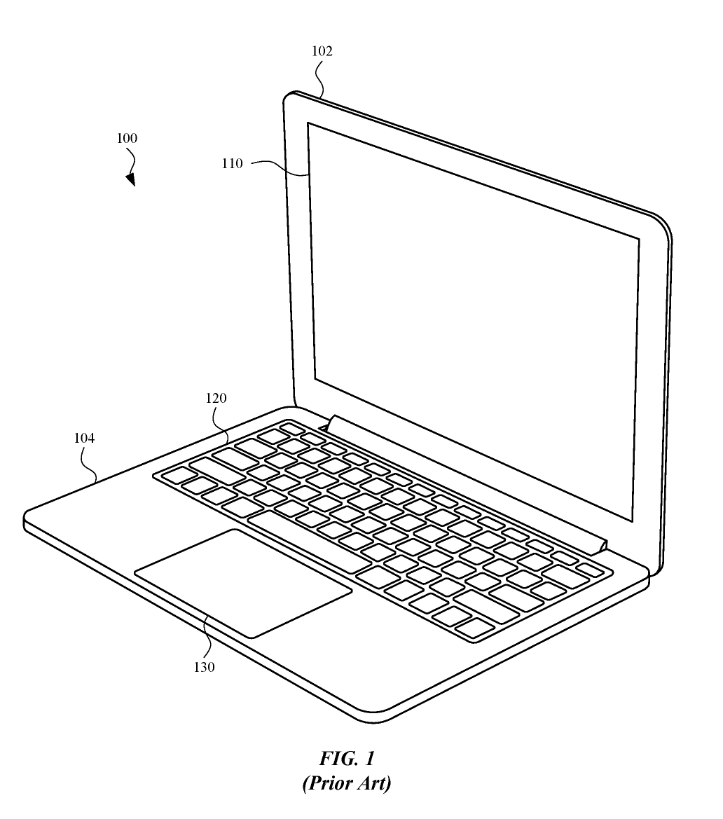

These and other embodiments are discussed below with reference to FIGS. 1-16. However, those skilled in the art will readily appreciate that the detailed description given herein with respect to these figures is for explanatory purposes only and should not be construed as limiting.

FIG. 1 illustrates a computing device 100, in accordance with the prior art. The computing device 100 is a laptop computer that includes a top portion 102 and a base portion 104. The top portion 102 can include operational components such as a display assembly 110, image sensors, audio device(s) (e.g., speaker, microphone, etc.), and the like. The display assembly 110 can include a liquid crystal display (LCD) panel and backlight array, an organic light emitting diode (OLED) panel, a touch-sensitive surface, and the like. The base portion 104 can include operational components such as a processor, a volatile memory, a non-volatile storage device (e.g., solid state devices (SSD), hard disk drives (HDD), etc.), audio device(s), and the like. The base portion 104 can also include input devices such as a keyboard 120, touchpad 130, biometric sensors, and the like.

Each of the top portion 102 and the base portion 104 can include an enclosure that defines a cavity. The enclosure can be referred to as a housing, structural component, body, or the like. The operational components for each of the top portion 102 and the base portion 104 are included in the cavity and/or secured to the enclosure. The enclosure can include multiple structural members formed into an assembly using mechanical fasteners, pressure sensitive adhesive (PSA), epoxies, or some other assembly technique such as spot welding, ultrasonic welding, friction welding, interlocking features, and any other technically feasible techniques for assembling structural members to form an assembly. The structural members can be manufactured from metal (e.g., aluminum, steel, metal alloys, etc.), plastic polymers (e.g., polyethylene—PE, polyvinyl chloride—PVC, etc.), ceramics (e.g., glass, porcelain, etc.), or composites of the aforementioned materials.

The computing device 100 can be configured in a closed configuration or an open configuration. As depicted in FIG. 1, the computing device 100 is in an open configuration. As used herein, a closed configuration refers to a relative positioning of the top portion 102 and the base portion 104 such that the surface of the display assembly 110 is in close proximity to a surface of the keyboard 120. In contrast, an open configuration refers to a relative positioning of the top portion 102 and the base portion 104 such that the display assembly 110 is visible and the keyboard 120 and touchpad 130 are accessible to a user.

Although the computing device 100 depicted in FIG. 1 is shown as a laptop computer, the computing device 100 can take other forms such as a tablet computer, mobile phone, desktop computer, game console, television, set-top box, and the like. Any consumer electronic device or industrial device including at least one structural component attached to another structural component by mechanical fasteners, adhesive, or welds can potentially be improved using the fasteners disclosed herein.

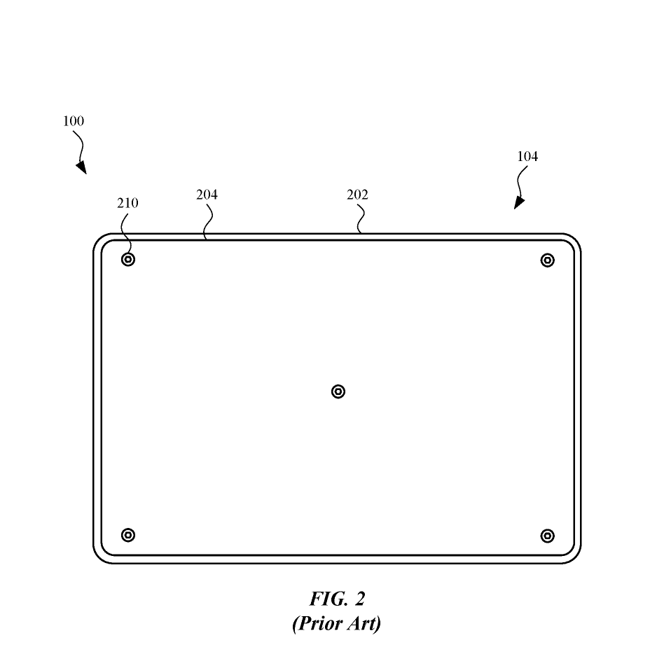

FIG. 2 shows a bottom view of the base portion 104 of the computing device 100, in accordance with the prior art. As depicted in FIG. 2, the base portion 104 includes a housing 202 and a cover 204 attached to the housing 202 via a number of mechanical fasteners 210. The cover 204 can be formed from aluminum and include through holes for screws that thread into corresponding threaded holes formed in the interior of the housing 202. The through holes can be counter-bored on an exterior surface of the cover 204 such that the heads of the screws sit flush with or below (i.e., sub flush with respect to) the exterior surface of the cover 204.

It will be appreciated that the bottom surface of the base portion 104 of the laptop computer would be cleaner, aesthetically, without the holes formed therein. However, access to the operational components disposed within a cavity of the housing 202 is still required such that means for attaching the cover 204 to the housing 202 should be easily reversible to provide for non-destructive disassembly and re-assembly of the base portion 104 of the computing device 100.

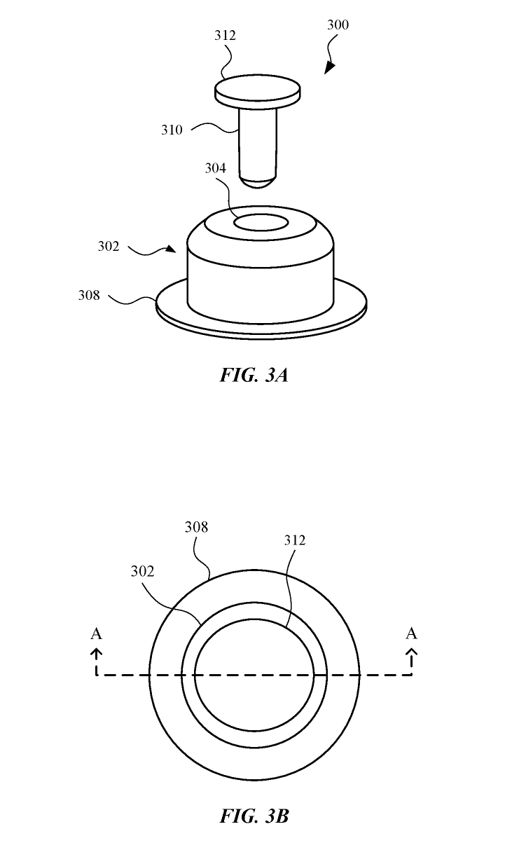

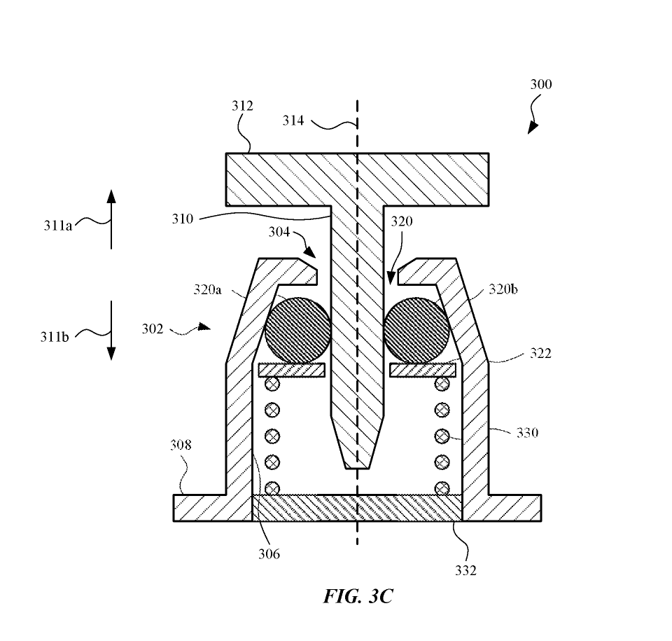

FIGS. 3A-3C illustrate a fastener 300, in accordance with some embodiments. The fastener 300 includes a receiver housing 302 and a pin 310. As depicted in FIG. 3A, the receiver housing 302 has an opening 304 formed in a top surface of the receiver housing 302. In some embodiments, the receiver housing 302 includes a flange 308 formed at the bottom surface of the receiver housing 302. The opening 304 accepts the pin 310 inserted into the receiver housing 302. Generally, the term “pin” refers to a component having a cylindrical surface characterized by dimensions including a diameter and a length. The pin 310 can also be referred to as a cylinder or a shaft. Although not shown, the shape, and in particular the cross sectional shape, may include other polygonal shapes in which the cross sectional shape defines a symmetrical shape. In some embodiments, the pin 310 can include a flange 312 formed on one end of the pin 310. The flange 308 of the receiver housing 302 can be utilized to attach the receiver housing 302 to a first component, and the flange 312 of the pin 310 can be utilized to attach the pin 310 to a second component that can be secured to the first component. For example, the flanges can be welded or glued to a surface of a corresponding component.

FIG. 3B shows a top view of the fastener 300. The receiver housing 302, flange 308, and flange 312 are visible in the top view. A section line A-A is also shown in FIG. 3B, which represents a cutting plane for a cross sectional view of the fastener 300 depicted in FIG. 3C.

As depicted in FIG. 3C, the receiver housing 302 and pin 310 can be symmetric around a central axis 314. The receiver housing 302 encloses a number of spherical components 320, such as a spherical component 320a and a spherical component 320b. As used herein, the term “spherical component” refers to a solid material having a continuous surface with points on the surface equidistant from a center of the solid material. The spherical components 320 may act as bearings designed to rotate along an interior surface 306 of the receiver housing 302 and the pin 310. The spherical components 320 are typically made of a hard material such that the material can sustain a load with minimal, if any, deformation. The spherical components 320 are typically made of steel or steel alloys, but can also be made from other metals or ceramics. In some embodiments, the spherical components 320 sit on a washer 322 or some other platform with a receiving surface for the spherical components 320. A spring 330 can be used to bias the washer 322 towards the top surface of the receiver housing 302. The spring 330, washer 322, and spherical components 320 are retained inside the receiver housing 302 by backing plate 332. The backing plate 332 can be press fit into the receiver housing 302 from the bottom surface of the receiver housing 302. Alternatively, the backing plate 332 can be welded, glued, or otherwise affixed to the receiver housing 302.

In some embodiments, the backing plate 332 is omitted and the spring 330 and washer 322 are retained within the retainer housing 302 via tabs formed from a portion of the receiver housing 302 material. In such embodiments, the receiver housing 302 can be formed from a sheet metal that is stamped (e.g., pressed) into a desired shape. Subsequently, the tabs can be cut from the flange 308 and folded back towards the central axis 314.

In some embodiments, the receiver housing 302 has a height that is less than 10 mm. The receiver housing 302 is sized to fit within the small envelope of various computing devices. In exemplary embodiments, the height of the receiver housing 302 is approximately 5 mm, the diameter of the pin 310 is less than, but proximate to, 1 mm, and the diameter of the spherical components 320 is greater than, but proximate to, 1 mm. The diameter of the opening 304 in the receiver housing 302 can be greater than the diameter of the pin 310 but less than that of the spherical components 320 to ensure that the spherical components 320 are retained within the receiver housing 302.

The fastener 300 operates as a one-way retaining mechanism. As the pin 310 is inserted into the opening 304, the pin 310 engages with the spherical components 320. As the pin 310 is moving into the receiver housing 302, the spherical components 320 are pressed toward the backing plate 332 (or a bottom surface of the receiver housing 302 when the backing plate 332 is omitted), thereby compressing the spring 330. The spherical components 320 can rotate freely against the surface of the pin 310, as there is clearance between the pin 310 and the surface of the receiver housing 302 that is greater than the diameter of the spherical components 320. However, when the direction of the pin 310 is reversed to attempt to extract the pin 310 from the opening 304, the pin 310 wedges the spherical components 320 against the interior surface 306 of the receiver housing 302. At a location within the receiver housing 302, the inner diameter begins to decrease such that the interior surface 306 slopes towards the central axis 314 proximate a top portion of the receiver housing 302. As a result, the clearance between the pin 310 and the interior surface 306 is less than the diameter of the spherical components 320, which causes the spherical components 320 to wedge between the pin 310 and the interior surface 306. The spherical components 320 exert a normal force against the cylindrical surface of the pin 310 and the interior surface 306 of the receiver housing 302 as the spherical components 320 try to rotate against the pin 310 as the pin 310 is extracted. Rotation of the spherical components 320 that is induced by the pin 310 being extracted drives the spherical components 320 upward (in the direction of the arrow 311a) against the interior surface 306, further increasing the normal force, thereby locking the pin 310 in place. The pin 310 cannot be simply pulled out of the opening 304, due in part to the high normal force creating large friction forces against the surface of the pin 310 that restrict extraction of the pin 310 from the receiver housing 302. Even for relatively small fasteners, the pin 310 can withstand up to hundreds of Newtons of force before the fastener 300 will fail due to deformation of the receiver housing 302, pin 310, and/or spherical components 320.

It should be noted that the pin 310 can, in at least one embodiment, take the form of a rod that is polygonal in cross section as well as, in yet another embodiment, have a cylindrical cross section. Moreover, the pin 310 can take any shape that is circularly symmetric and at least partially matches the spherical components 320, such as a scalloped shape (as a non-limiting example. In this way, the spherical components 320 can be located around a circumference of the pin 310.

The pin 310 can be extracted from the opening 304 in the receiver housing 302 by moving the spherical components 320 (in the direction of the arrow 311b, which is generally opposite to the direction defined by the arrow 311a) to increase the clearance between the pin 310 and the interior surface 306, which lessens the normal force exerted by the spherical components 320 against the pin 310. In some embodiments, the spherical components 320 are ferromagnetic and an attractive force can be imparted on the spherical components 320 by a magnetic field from a magnet placed proximate the backing plate 332 (or a bottom surface of the receiver housing 302 when the backing plate 332 is omitted). The attractive force should be sufficiently large enough to overcome the frictional forces of the spherical components 320 wedged against the receiver housing 302 and the pin 310, as well as the bias force in the direction of the arrow 311a against the spherical components 320 from the spring 330. Consequently, the magnet should be large enough to create a magnetic field of sufficient strength to retract the spherical components 320 towards the bottom surface of the receiver housing 302. Once the spring 330 is at least partially compressed and the spherical components 320 have been retracted, the pin 310 can be extracted from the opening 304.

In some embodiments, the opening 304 in the receiver housing 302 is chamfered, rounded, or otherwise flared to aid in guiding the pin 310 into the center of the receiver housing 302. A tip of the pin 310 can also be chamfered, tapered, rounded, or the like to aid in engaging with the opening 304. It will be appreciated that the fastener 300 can be utilized to attach a first component to a second component. The pin 310 is attached to a first component and the receiver housing 302 is attached to the second component. Consequently, the geometry of the opening 304 and the tip of the pin 310 can attempt to accommodate some misalignment when the first component is being mated with the second component. The geometry will help align the pin 310 with the opening 304.

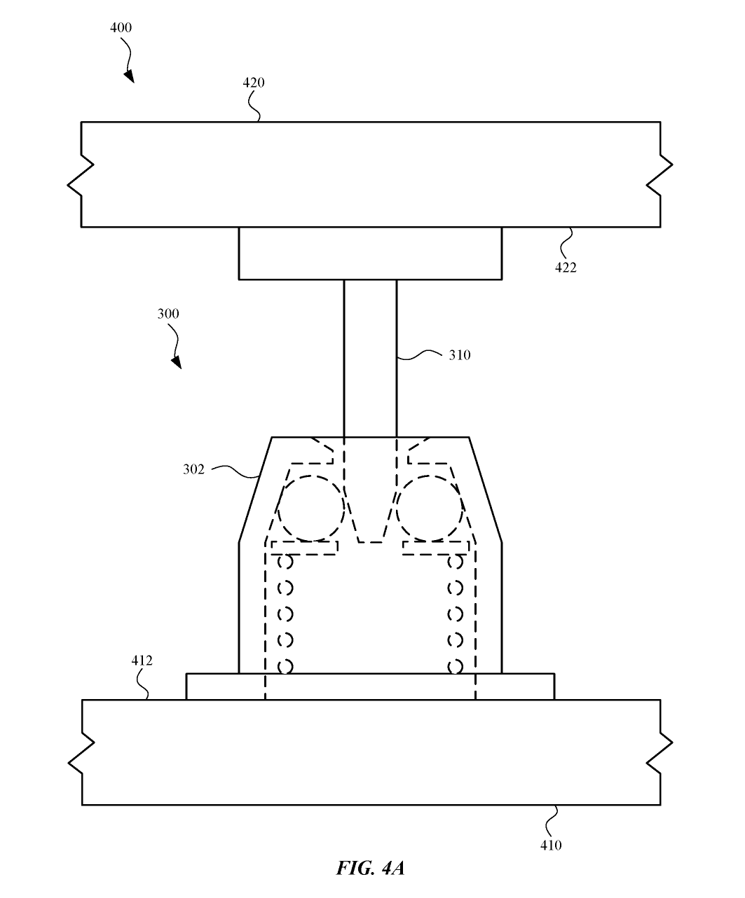

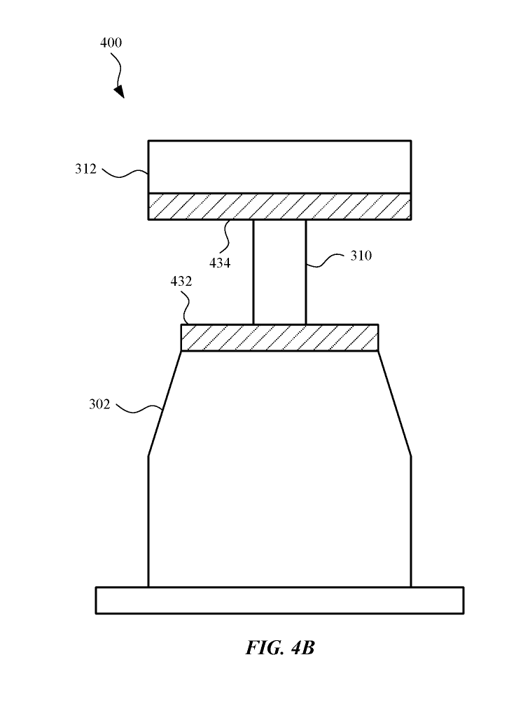

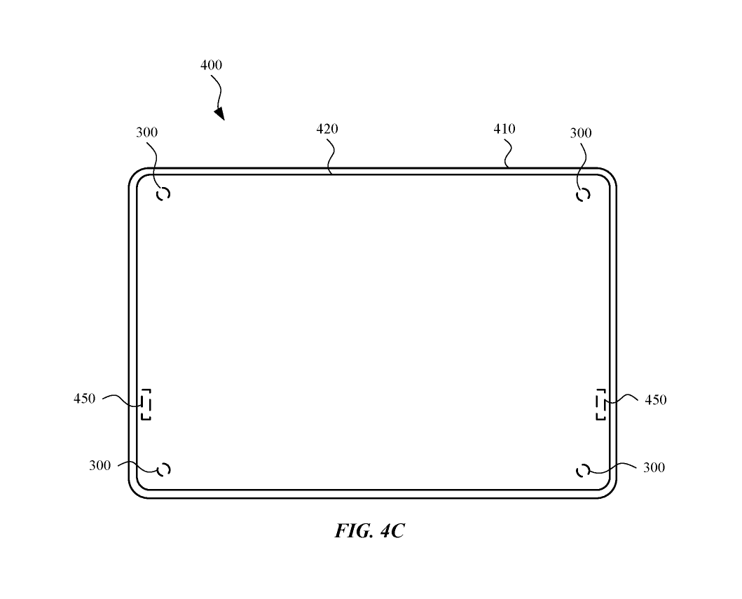

FIGS. 4A-4C illustrate a fastener 300 utilized to secure an enclosure of a computing device 400, in accordance with some embodiments. As shown, the receiver housing 302 is attached to an interior surface 412 of a first structural component 410 of the computing device 400. The pin 310 is attached to an interior surface 422 of a second structural component 420 of the computing device 400. The first structural component 410 is then mated with the second structural component 420 by inserting the pin 310 into the opening 304 in the receiver housing 302. The first structural component 410 and the second structural component 420 enclose one or more operational components (not explicitly shown) of the computing device 400 within a cavity formed between the interior surface 412 and the interior surface 422.

In some embodiments, the computing device 400 is a laptop computer similar to the computing device 100 (shown in FIGS. 1 and 2). However, the mechanical fasteners 210 (shown in FIG. 2) have been omitted and replaced by the fastener 300. The fastener 300 do not require through holes formed in the material of the structural housing components and, therefore, the fastener 300 are not visible through the exterior surfaces of the computing device 400, which are generally opaque and obscure the components located within the cavity of the computing device 400. It will be appreciated that the structural components of the computing device 400 could be transparent or translucent, which would enable the fastener 300 to be visible through the exterior surfaces but not accessed like conventional mechanical fasteners disposed in through holes formed in the structural components, as no through holes are present regardless of the transparency of the structural housing components.

Although not explicitly shown in FIG. 4A, the first structural component 410 and the second structural component 420 can include surfaces that act as one or more stops that limit the ingress of the pin 310 into the opening of the receiver housing 302. These stops can prevent the pin 310 from bottoming out against the interior surface 412 of the first structural component 410. In some embodiments, the stops can be hard stops formed from a rigid material, or soft stops. In the latter case, a compliant material is disposed between the surfaces that act as a stop. The compliant material can be, e.g., a rubber material or the like that resists further ingress of the pin 310, but nevertheless can be compressed further under additional force. The soft stop aids in releasing the spherical components 320 within the receiver housing 302 when the structural components are disassembled by allowing the pin 310 to be further pressed into the receiver housing 302 concurrently with the spherical components 320 being subjected to a magnetic field that is attracting the spherical components 320 towards the first structural component 410.

As depicted in FIG. 4B, in some embodiments, a compliant material 432 can be affixed to the top surface of the receiver housing 302 such that the compliant material is disposed between the flange 312 and the top surface of the receiver housing 302 when the pin 310 is inserted into the opening 304. Also, in some embodiments, a compliant material 434 can be affixed to the bottom surface of the flange 312 on the pin 310 such that the compliant material is disposed between the flange 312 and the top surface of the receiver housing 302 when the pin 310 is inserted into the opening 304. In the embodiment shown in FIG. 4B, the compliant material 432 and the compliant material 434 can be affixed to both the top surface of the receiver housing 302 and the bottom surface of the flange 312. Such material can perform a similar function as a soft stop formed between surfaces of the structural components to which the fastener is attached. In some embodiments, the compliant material 432 or the compliant material 434 can be a spring, such as a Belleville washer, a wave spring, or the like that provides for some compression of the compliant material 432 and/or the compliant material 434.

It will be appreciated that the fastener 300 can replace traditional fasteners such as the mechanical fasteners 210 utilized in the housing for the computing device 100. However, the use of fasteners the 300 does not preclude the use of other traditional fasteners as well. As depicted in FIG. 4C, a housing that includes the first structural component 410 and the second structural component 420 for the computing device 400 utilizes four fastener 300 in place of traditional mechanical fasteners such as screws or rivets. However, the first structural component 410 and the second structural component 420 can also be attached via other means in addition to the fastener 300. For example, the first structural component 410 can incorporate spring clips 450 that deflect as the first structural component 410 engages the second structural component 420 and lock with a mating surface of the second structural component 420 once the second structural component 420 is sufficiently seated in the opening of the first structural component 410. A tool must be inserted into a gap between the first structural component 410 and the second structural component 420 to disengage the spring clips 450. The combination of the spring clips 450 with the fastener 300 requires multiple actions to disassemble the housing, thereby providing additional tamper resistance to the computing device 400.

In addition, although not explicitly shown in FIGS. 4A-4C, the first structural component 410 and/or the second structural component 420 may include assemblies of components that perform various functions and are not limited to a simple structure formed of a base material, such as metal or plastic. For example, in some embodiments, the first structural component 410 can be a keyboard assembly and the second structural component 420 can be a base housing for the keyboard assembly. The keyboard assembly can then be attached to the housing using the fastener 300 to create a cavity within the housing for additional operational components of the computing device 100.

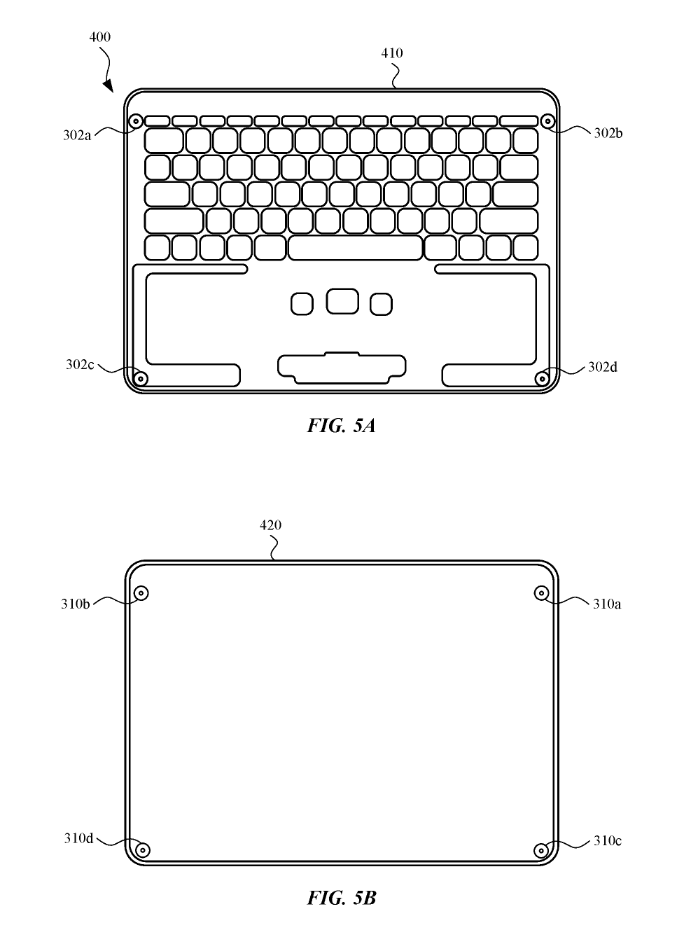

FIGS. 5A-5B illustrate the base portion of the computing device 400 incorporating the fastener 300, in accordance with some embodiments. The computing device 400 can be a laptop computer. The base portion of the computing device 400 includes the first structural component 410 and the second structural component 420, which can also be referred to as a housing and a cover of the base portion of the laptop computer, respectively.

In some embodiments, the computing device 400 includes a number of fasteners, each of which include the features of the fastener 300 (shown in FIGS. 3A-3C) located at various positions relative to the first structural component 410 and the second structural component 420. For example, as depicted in FIG. 5A, the computing device 400 can include a receiver housing 302a, a receiver housing 302b, a receiver housing 302c, and a receiver housing 302d located proximate the four corners of the first structural component 410. It will be appreciated that the aforementioned receiver housings do not have to be co-planar (e.g., do not have to be attached to a single flat surface), but could be attached to different surfaces at different elevations within the topography of the first structural component 410. However, the receiver housings are required to be aligned such that the central axis 314 of the receiver housing 302 are parallel.

In addition, as depicted in FIG. 5B, the computing device 400 includes a pin 310a, a pin 310b, a pin 310c, and a pin 310d designed to mate/enter the receiver housing 302a, the receiver housing 302b, the receiver housing 302c, and the receiver housing 302d, respectively. The pin 310a, the pin 310b, the pin 310c, and the pin 310d are located proximate the four corners of the second structural component 420. The second structural component 420 can then be mated with the first structural component 410 by, for example, rotating the second structural component 420 and inserting the pin 310a, the pin 310b, the pin 310c, and the pin 310d into the receiver housing 302a, the receiver housing 302b, the receiver housing 302c, and the receiver housing 302d, respectively, thereby enclosing the cavity formed in the first structural component 410.

Furthermore, although multiple fasteners are used in parallel to mate two corresponding components, a set of fasteners can also be used to mate three or more components. For example, a printed circuit board can be attached to a first structural component using a first subset of fasteners and then a second structural component can be attached to the first structural component using a second subset of fasteners, with the first and second subsets of fasteners having any feature described for the fastener 300 (shown in FIGS. 3A-3C). As another example, the cover (e.g., the second structural component 420) can be designed as multiple pieces that can be removed separately from a housing (e.g., the first structural component 410) to provide access to different operational components of the computing device 400 by removing different portions of the cover independently.

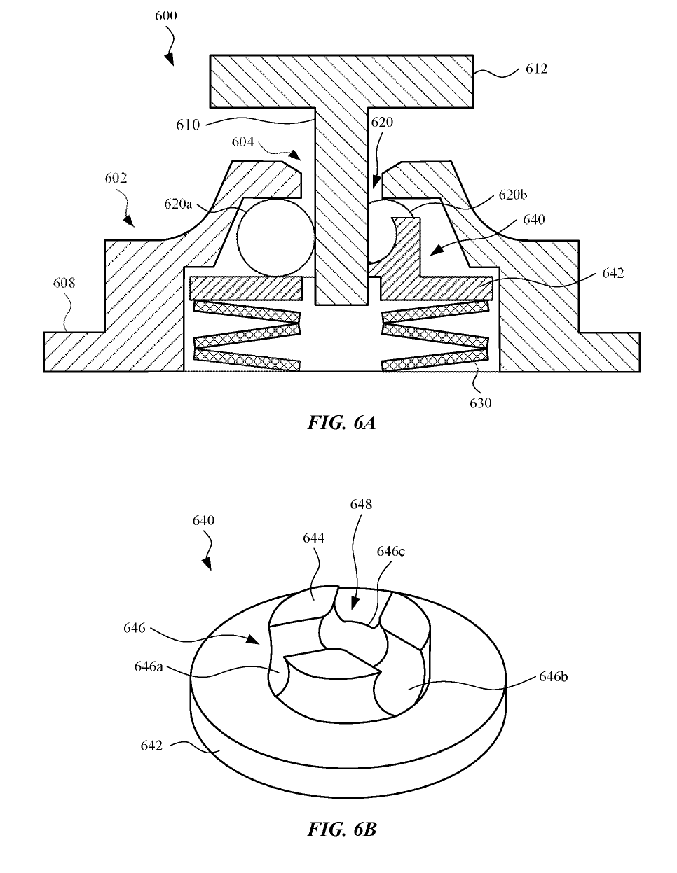

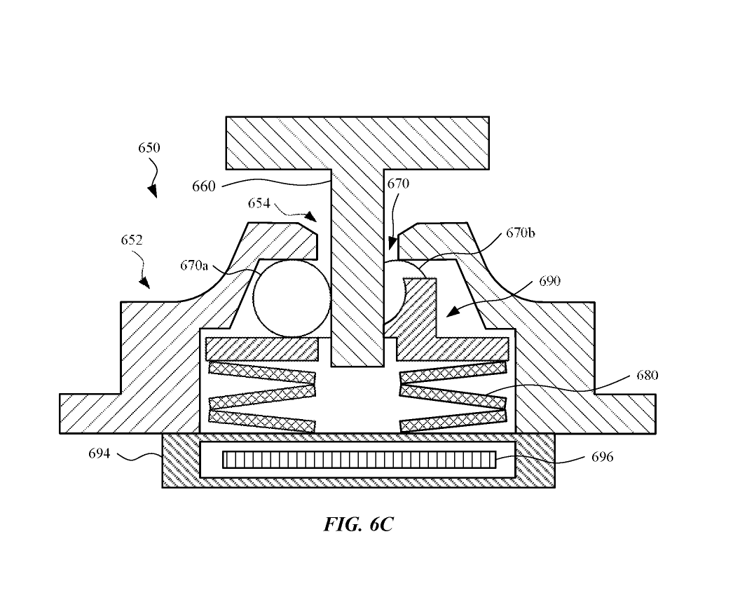

FIG. 6A illustrates partial cross sectional view of a fastener 600, in accordance with some embodiments. The fastener 600 includes a receiver housing 602 that has an opening 604 in the top surface of the receiver housing 602. A pin 610 can be inserted into the opening 604. When the pin 610 is positioned in the opening 604, the pin 610 may contact a number of spherical components 620, such as a spherical component 620a and a spherical component 620b, retained within the receiver housing 602. In some embodiments, the spherical components 620 are further constrained within a holder 640. The bearing holder 640 includes a flange 642 that provides a receiving surface for the spherical components 620. The holder 640 is biased towards the top surface of the receiver housing 602 by a biasing module 630 that engages a bottom surface of the flange 642. The biasing module 630 may include a structural component(s) with a variable spring constant. For instance, the biasing module 630 may include stack of one or more Belleville washers. Alternatively, the biasing module 630 can be replaced by a wave spring, a conventional coil spring, or generally any component or system that is compressible and provides a biasing force to the holder 640. As shown, the biasing module 630 is a relatively uncompressed state, and the spherical components 620 engage a top portion of the receiver housing 602. However, although not shown, a force provided by the holder 640 can compress the biasing module 630, thereby causing the spherical components 620 to disengage from the top portion of the receiver housing 602.

The receiver housing 602 includes a flange 608, and the pin 610 includes a flange 612. The flange 608 and the flange 612 can be used for attaching the receiver housing 602 and pin 610, respectively, to mating components via, e.g., welding, adhesive, or mechanical fasteners. It will be appreciated that the fastener 600 is shown without a backing plate or tabs for retaining the stack of the biasing module 630. In some embodiments, the biasing module 630 and the holder 640 are only retained inside the receiver housing 602 once the receiver housing 602 is attached to a corresponding component (such as the backing plate 332, shown in FIG. 3C), with a surface of the component acting as a backing plate to compress the biasing module 630 and bias the holder 640 toward the top surface of the receiver housing 602. In other embodiments, the biasing module 630 and holder 640 can be retained within the receiver housing 602 by a separate and distinct backing plate that is press fit or otherwise secured within the opening in the bottom surface of the receiver housing 602. Alternatively, tabs can be formed from the flange and bent into the opening to retain the biasing module 630 and holder 640.

It will be appreciated that the spherical components 620 are retained in the bearing holder 640 rather than being retained loosely within the receiver housing 602. In some embodiments, three spherical components are retained within the receiver housing 602. However, the geometry of the pin 610 and the spherical components 620 are such that the spherical components 620, retained loosely, could shift to one side of the pin 610, which could reduce the force restricting the extraction of the pin 610 from the opening 604. Ideally, the spherical components 620 are evenly spaced around the perimeter of the pin 610 such that the normal forces imparted against the pin 610 by the spherical components 620 are balanced and do not cause any deflection in the pin 610. One technique for ensuring proper spacing is to carefully balance the diameters of the pin 610 and spherical components 620 such that an integer number of the spherical components 620 spaced evenly around the pin 610 each contact two adjacent spherical components so the spherical components 620 cannot shift to one side of the pin 610. Another technique that lets a designer adjust the diameter and number of the spherical components 620 independently from the diameter of the pin 610 is to retain a smaller number of spherical components 620, properly spaced, in the holder 640.

FIG. 6B illustrates the holder 640 of FIG. 6A, in accordance with some embodiments. The flange 642 provides a bottom surface of the holder 640 for the biasing module 630 (shown in FIG. 6A) to press against. The holder 640 may include a boss 644 on the opposite side of the flange 642. The boss 644 may include a number of holes 646, such as a hole 646a, a hole 646b, and a hole 646c, formed therein for retaining the spherical components 620 individually. The spherical components 620 (shown in FIG. 6A) can be placed in the holes 646 and retained in the holes 646 by the surfaces of the receiver housing 602 and the pin 610 when the pin 610 is inserted into the opening 604 of the receiver housing 602. The holder 640 also includes a hole 648, collinear with a central axis of the holder 640, which enables the pin 610 to pass through the center of the holder 640. It will be appreciated that the diameter of the hole 648 can be less than the diameter of the spherical components 620 such that the spherical components 620 cannot fall out of the holder 640 and into the hole 648 when the pin 610 is not inserted in the receiver housing 602. As shown, the flange 642 and the boss 644 are integrally formed with each other. However, in some embodiments, the flange 642 and the boss 644 are separable parts. In this regard, the boss 644 may lie on the flange 642.

FIG. 6C illustrates a partial cross sectional view of an alternate embodiment of a fastener 650, further showing a magnetic field generator 694 integrated with the fastener 650, in accordance with some described embodiments. Similar to prior embodiments, the fastener 650 includes a receiver housing 652 that has an opening 654 in the top surface of the receiver housing 652. The fastener 650 may further include a pin 660 that can be inserted into the opening 654. When the pin 660 is positioned in the opening 654, the pin 660 may contact a number of spherical components 670, such as a spherical component 670a and a spherical component 670b, retained within the receiver housing 652. The spherical components 670 can be constrained within a holder 690 that is biased towards the top surface of the receiver housing 652 by a biasing module 680. The structure shown and described in FIG. 6C may include any features previously described for their corresponding structure.

The magnetic field generator 694 is designed to provide a magnetic field based upon an electrical current input. In this regard, the magnetic field generator 694 may include a coil 696 that forms an electromagnet (e.g., solenoid) when electrical current passes through the coil 696. The biasing module 680 and/or the holder 690 may include one or more magnetically attractable materials. Alternatively, biasing module 680 and/or the holder 690 may include a permanent magnet. In either case, the magnetic field generator 694 is designed and positioned to generate a magnetic field to magnetically couple with the biasing module 680 and/or the holder 690 (depending upon which component(s) include a material that is magnetically attracted to the magnetic field provided by the magnetic field generator 694). It should be noted that one of ordinary skill in the art for magnets would provide a magnetic field by magnetic field generator 694 that includes an opposite polarity as compared to the polarity of the biasing module 680 and/or the holder 690 (depending upon which component(s) include a material that is magnetically attracted to the magnetic field provided by the magnetic field generator 694). When the holder 690 is formed for a magnetically attractable material or a magnet, the magnetic field generator 694 can provide a magnetic field that causes magnetic attraction between the holder 690 and the magnetic field generator 694, thereby compressing the biasing module 680 and causing the holder 690 to move in a direction toward the magnetic field generator 694. When the biasing module 680 is formed for a magnetically attractable material or a magnet, the magnetic field generator 694 can provide a magnetic field that causes magnetic attraction between the biasing module 680 and the magnetic field generator 694, thereby compressing the biasing module 680 and causing the holder 690 to move in a direction toward the magnetic field generator 694. In either cases, the spherical components 670 are moved away (i.e., disengaged) from the top portion of the receiver housing 652 when the biasing module 680 is in the compressed state. When the electrical current is no longer provided to the magnetic field generator 694, the magnetic field generator 694 ceases generating a magnetic field, and the biasing module 680 decompresses, causing the holder 690 to return to its original position. In the decompressed state of the biasing module 680, the spherical components 670 are again engaged with the top portion of the receiver housing 652. It should be understood that the spring constant of the biasing module 680 should be selected such that the magnetic attraction force provided by the magnetic field from the biasing module 680 overcomes the biasing force provided by the biasing module 680.

While FIG. 6C shows the magnetic field generator 694 positioned against the receiver housing 652, the magnetic field generator 694 may be separated from the receiver housing 652 by a housing component, or other structural component, of a portable electronic device (not shown in FIG. 6C). Also, it should be noted that in order to use the magnetic field generator 694, the housing component of the portable electronic device should ideally not be formed from ferrite, steel, or other materials that are magnetically attracted to the magnetic field generator 694.

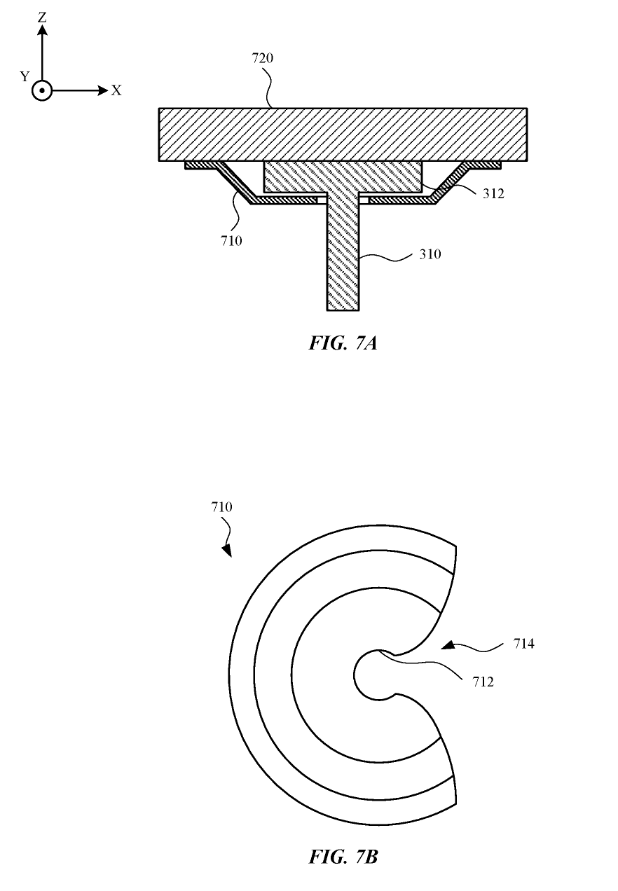

FIGS. 7A-7B illustrate a means for attaching a pin 310 to a wall of a structural component, in accordance with some embodiments. As shown, the pin 310 includes a flange 312 attached to a structural component 720, which may include a housing component of a portable electronic device. Also, a pin holder 710 is used to hold the pin 310. In some embodiments, the pin 310 is permanently, or semi-permanently, attached to a structural component using laser welding, a press fit, adhesive, swaging, or any other means that couples the flange 312 of the pin 310 to the structural component 720. However, in operation, the pin 310 can be bent or broken off, thereby requiring replacement. In some embodiments, the pin 310 can be affixed to the wall in a way that allows for easy removal and replacement with a spare part. For example, the flange 312 of the pin 310 can include threads that can be in threaded engagement into a corresponding threaded hole formed in the structural component. However, threads can come loose or be stripped. Furthermore, it can be difficult to grip a small component such as the pin 310 in order to rotate the pin 310 while threading the pin 310 into the threaded hole.

In some embodiments, the pin holder 710 can be permanently affixed to the structural component. As depicted in FIG. 7B, the pin holder 710 can be formed by shaping a metal disc via forging. However, other shaping methods are possible. The metal disc may include a hole 712 formed therein through which the shaft of the pin 310 can protrude. The diameter of the hole 712 is greater than a diameter of the pin 310 (shown in FIG. 7A), where the difference in diameters can be tailored to allow for a location tolerance (e.g., in an X-Y plane where the Z-axis is coaxial with the pin 310) that allows for some misalignment of the pin 310 with the receiver housing 302 (shown in FIG. 3A). The pin holder 710 is laser welded or otherwise fixed to the wall of the structural component 720 (shown in FIG. 7A).

In some embodiments, the pin 310 can be inserted into an opening 714 in the side of the pin holder 710, allowing for easy removal and replacement of the pin 310. The opening is configured such that the opening in the hole 712 is slightly smaller than the diameter of the pin 310. The pin holder 710 is flexible enough, or plastically deformable, to deflect to allow the pin 310 to be inserted into the hole 712, while also releasing back into the original shape once the pin 310 has been fully inserted into the pin holder 710. The geometry of the opening 714 is designed to retain the pin 310 in the pin holder 710 until a sufficient lateral force causes a deflection of the pin holder 710 sufficient to permit removal of the pin 310. The flange 312 of the pin 310 (shown in FIG. 7A) retains the pin 310 in the pin holder 710 in an axial direction (e.g., a Z-direction). The pin holder 710 should be of sufficient thickness to withstand the axial force placed on the pin 310 by the spherical components 320 (shown in FIG. 3C) when inserted into the receiver housing 302 (shown in FIG. 3C).

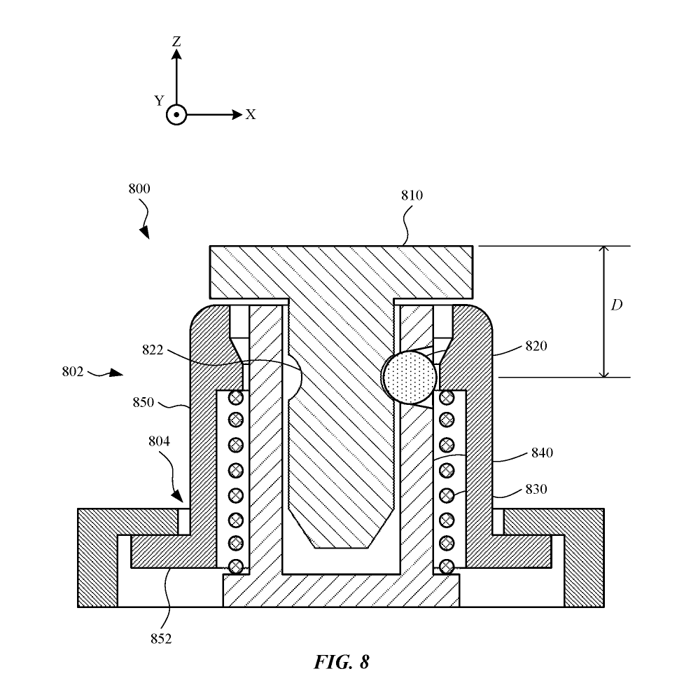

FIG. 8 illustrates a partial cross section of fastener 800, in accordance with some embodiments. The fastener 800 includes a receiver housing 802 that has an opening 804 in the top surface of the receiver housing 802. The receiver housing 802 retains a release mechanism 850 surrounding a holder 840. The release mechanism 850 is biased against an inner surface of the receiver housing 802 by a biasing module 830, which may include any feature(s) previously described for a biasing module. More specifically, the release mechanism 850 includes a flange 852 that has a diameter greater than the diameter of the opening 804 such that the release mechanism 850 is retained within the receiver housing 802 by the flange 852, with at least some tolerance of movement in the X-Y plane. In some embodiments, the pin 810 can be fixed in relation to a corresponding structural component while the receiver housing 802 allows some flexibility to accommodate normal assembly tolerances associated with attachment of the fastener 800 to the structural components.

The release mechanism 850 includes an opening that accepts the holder 840. The holder 840 also includes an opening formed in the top surface of the holder 840 that is configured to accept the pin 810. The pin 810 includes a detent feature 822, the center (or approximate center) of which is located at a distance D from the top surface of the pin 810. The detent feature 822 may wrap around the circumference of the pin 810, or may be located in multiple, discrete locations. The detent feature 822 interacts with a spherical component 820 located in a hole in the holder 840 to locate the pin 810 in a Z-direction, relative to the holder 840, that is collinear with a central axis of the pin 810. When the receiver housing 802 is attached to a component, the holder 840 is biased against a surface of the component, which locates the surface of the component relative to the top surface of the pin 810, which can be attached to a separate component.

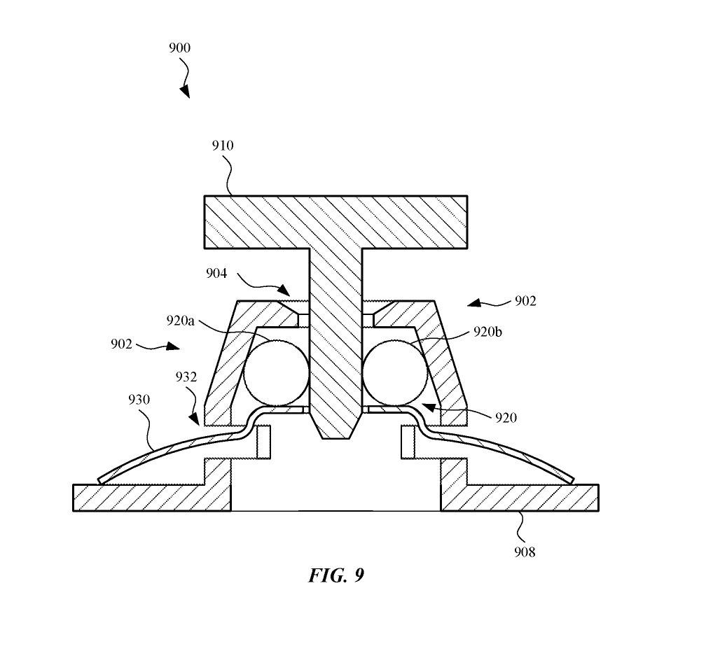

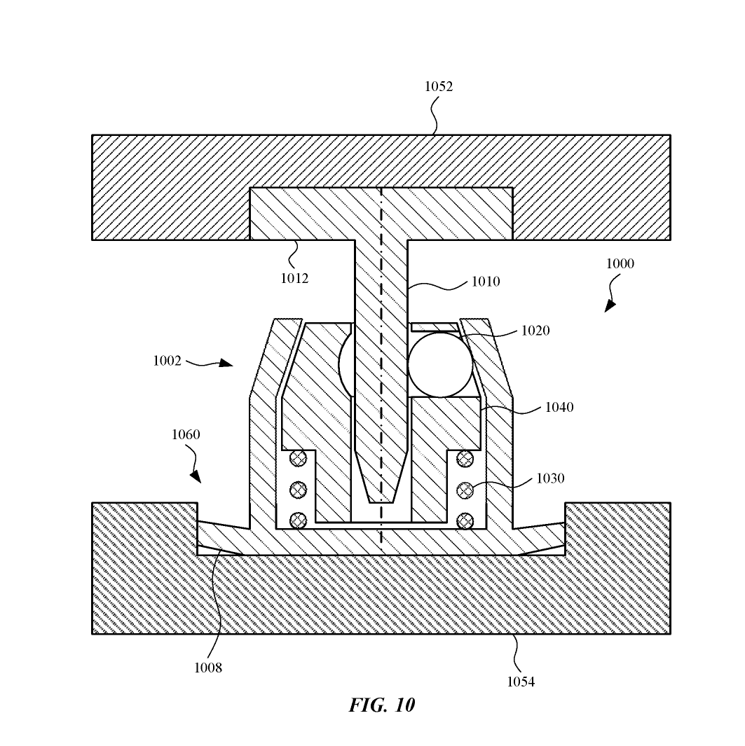

In operation, the release mechanism 850 is ferromagnetic and, therefore, is attracted to a magnetic element (not shown in FIG. 9), such as a permanent magnet, electromagnet, etc., that generates a magnetic field brought proximate the bottom surface of the receiver housing 802. Under the influence of the magnetic field, the release mechanism 850 moves generally along the Z-direction away from the pin 810. The movement of the release mechanism 850 compresses the biasing module 830 and releases the spherical component 820 to move away from the pin 810 due to the geometry of the inner surface of the release mechanism 850. The pin 810 can then be extracted from the holder 840, and subsequently, a component attached to the pin 810 is released from a component attached to the receiver housing 802. It will be appreciated that, as depicted in FIG. 8, the release mechanism 850 also needs to be retracted in order to insert the pin 810 into the hole of the release mechanism 850. Unlike the fastener 300 shown in FIGS. 3A and 3C or the fastener 600 shown FIG. 6A, which rely on friction forces to restrict the extraction of a pin from the opening in a receiver housing, the fastener 800 shown in FIG. 8 relies on the interference between the spherical component 820 and the detent feature 822 in the pin 810 to prevent the pin 810 from being extracted from the opening in the holder 840. This means that a magnet, generating a magnetic field for retracting the release mechanism 850 along the Z-axis to disengage from the receiver housing 802, is also needed to insert the pin 810 into the opening in the holder 840. In addition, a magnet is required to provide a similar movement of the release mechanism 850 in order to extract the pin 810 from the opening in the holder 840.

In addition, as depicted in FIG. 8, the holder 840 and the release mechanism 850 are allowed to float within the receiver housing 802. In other words, the holder 840 and the release mechanism 850 are not permanently affixed to the receiver housing 802, and the holder 840 and the release mechanism 850 can achieve at least some relative movement. The clearance between the opening 804 and the outer surface of the release mechanism 850 (e.g., a difference in diameters), as well as a clearance between the inner surface of the release mechanism 850 and the outer surface of the holder 840, account for some freedom in the location of the opening in the holder 840 relative to the receiver housing 802. This can be useful when using multiple fasteners to mate two components of, for example, a portable electronic device. For example, there is a tolerance related to the location of each of the pins attached to a component. There is a separate tolerance related to the location of each of the corresponding receiver housings attached to another component. By allowing the opening in the holder 840 to float within the receiver housing, or allowing the pin to float within a separate housing similar to receiver housing 802, these tolerances can be accounted for in a manner that is similar to oversizing a through hole for a conventional mechanical fastener, such as a screw, in order to account for tolerances in the location of a threaded hole in a mating component.

The receiver housing 802 can be combined with the receiver housings for other fasteners to permit the pin 810 and/or the opening in the receiver housing 802 to float. For example, the receiver housing 802 can be placed over the receiver housing 302 (shown in FIGS. 3A-3C), such that the flange 308 is retained against the component attached to receiver housing 802 in the Z-direction, but allowed to float in the X- and Y-directions, within some tolerance as defined by the size of the opening 804 in the receiver housing 802.

FIG. 9 illustrates a partial cross sectional view of a fastener 900, in accordance with some embodiments. The fastener 900 includes a receiver housing 902 that has an opening 904 in the top surface of the receiver housing 902. The receiver housing 902 encloses a number of spherical components 920, such as a spherical component 920a and a spherical component 920b, which are biased towards a top surface of the receiver housing 902 by a biasing module 930. As shown in FIG. 9, the biasing module 930 includes a leaf spring. The biasing module 930 passes through openings 932 in the receiver housing 902 and bears against a flange 908 formed at a bottom surface of the receiver housing 902. The flange 908 may be required to have a diameter sufficient to provide a bearing surface for the ends of the biasing module 930. Alternatively, the biasing module 930 can bear against a surface of the component attached to the receiver housing 902 (when the flange 908 is not present). A pin 910 can be inserted into the opening 904, and pass through a hole in the center of the biasing module 930.

The spherical components 920 generate a normal force against the surface of the pin 910 that resists the extraction of the pin 910 from the opening 904 while the spherical components 920 are biased against the inner surface of the receiver housing 902. A magnetic field generated by a magnet (not shown in FIG. 9) placed proximate the bottom surface of the receiver housing 902 causes the biasing module 930, formed from a ferromagnetic material that is magnetically attracted to the magnet field, to be retracted towards the bottom surface of the receiver housing 902. The flange 908 may define the bottom surface of the receiver housing 902. As a result of the retraction of the biasing module 930, the spherical components 920 retract in the same direction as the biasing module 930, and the force, if any, between the spherical components 920 and the inner surface of the receiver housing 902 decreases, which enables the pin 910 to be extracted from the opening 904 in the receiver housing 902. The biasing module 930 embodiment depicted in FIG. 9 has some advantages over other embodiments, such as including fewer parts.

It will be appreciated that some aspects of a particular fastener can be combined with the aspects of other fasteners, as disclosed herein. For example, the fastener 300 (shown in FIGS. 3A-3C) or the fastener 900 can incorporate a holder (such as the holder 640, shown in FIG. 6B) to retain loose spherical components in a particular orientation in order to maintain the spherical components in a planar arrangement. As another example, one or more biasing modules can replace the conventional coil spring of fastener 800.

FIG. 10 illustrates a partial cross sectional view of a fastener 1000, in accordance with some embodiments. The fastener 1000 includes a receiver housing 1002 that has a cavity that receives and holds a holder 1040. The holder 1040 is biased towards a top surface of the receiver housing 1002 by a biasing module 1030, which may include any feature(s) previously described for a biasing module. The holder 1040 includes a through hole for accepting the shaft of a pin 1010 and a second blind hole that intersects the through hole at substantially a right angle. The second blind hole is sized to accommodate a spherical component 1020, which bears against a sloped surface of the receiver housing 1002 and a surface of the pin 1010 when the pin 1010 is inserted into the through hole in the holder 1040. Although the spherical component 1020 represents a single spherical component in FIG. 10, in other embodiments, two or more spherical components can be located in different blind holes formed radially around the through hole.

The receiver housing 1002 can include a flange 1008 formed on the bottom surface of the receiver housing 1002. The flange 1008 can be attached to a structural component 1054 using, e.g., laser welding or some other technically feasible means. In some embodiments, the flange 1008 can be press fit into a blind hole 1060 formed in the structural component 1054. In other embodiments, an external surface of the flange 1008 can be threaded to fit into a threaded hole formed in a structural component (not shown in FIG. 10). In yet other embodiments, the flange 1008 can be installed into a blind hole using a special rotary displacement punch tool. In yet other embodiments, such as where the structural component is completely enclosed within a second housing, the flange 1008 can include self-clinching features that require a through hole to enable installation. The pin 1010 may include a flange 1012 that is installed in a structural component 1052. It should be noted that the installation technique utilized for the receiver housing 1002 can be different from the installation technique for the pin 1010. For example, the pin 1010 can be installed in a manner that the pin 1010 is easily removable while the receiver housing 1002 can be installed in a manner that is permanent or semi-permanent.

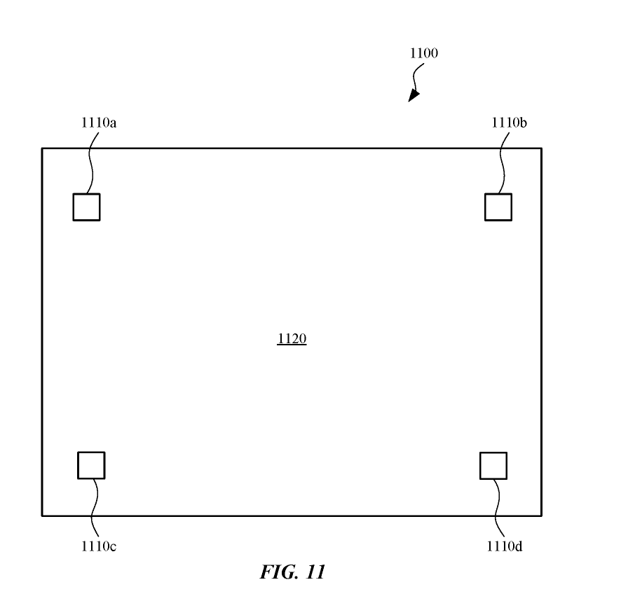

FIG. 11 illustrates a fixture 1100 used to access a cavity within a computing device, in accordance with some embodiments. The computing device may include the 400 shown in FIGS. 4A-4C. The fixture 1100 includes a number of magnets placed at different locations corresponding to a number of fasteners (and associated locations) implemented in the computing device 400. In some embodiments, the magnets are permanent magnets adhesively bonded to a substrate 1120. For example, the fixture 1100 may include a magnet 1110a, a magnet 1110b, a magnet 1110c, and a magnet 1110d. The substrate 1120 may include a sheet of material, with the material being selected from a polymer or an aluminum, as non-limiting examples.

In other embodiments, the aforementioned magnets can be electro-magnets that can be individually activated by a controller that generates signals for turning on a current to each of the electro-magnets. In such embodiments, various subsets of electro-magnets can be individually activated to release corresponding subsets of fasteners. This capability is especially useful when the fasteners are utilized to couple three or more separate components such that individual components can be released while other components remain coupled.

In some embodiments, one or more of the magnet 1110a, the magnet 1110b, the magnet 1110c, and the magnet 1110d is/are movable relative to the other magnets. In such embodiments, the fixture 1100 can be configured to access different electronic devices having a different configuration of fasteners. In some embodiments, the arrangement of the fasteners within the computing device 400 can be based on a serial number or other identifier of the computing device 400. The serial number or other identifier can be decoded to indicate a location of the fasteners within the device, and the fixture 1100 can be adjusted to move the magnets to the corresponding locations of the fasteners. Such embodiments can provide some level of tamper resistance that makes it more difficult to access the cavity within the computing device 400 without an understanding of the mapping of the serial number/identifier to the locations of the fasteners.

In other embodiments, tamper resistance can be implemented utilizing a polarity of electro-magnets within the fixture 1100 that can change polarity. Instead of relying on the ferromagnetic material in the spherical components or other components of the fasteners to release the pin under the influence of the magnetic field, the fasteners can incorporate a permanent magnet into the design of a holder, such as the holder 640 (shown in FIG. 6B). Thus, the retraction of the spherical components towards a bottom surface of the receiver housing under the influence of a magnetic field depends on the orientation of the magnetic dipole of the permanent magnet in the holder. Two different holders can be manufactured, with a permanent ring magnet attached to the holder with either a North Pole or a South Pole facing the bottom surface of the receiver housing. Then, these two different holders can be included in the different fasteners included in the electronic device. The polarity of electro-magnets included in the fixture 1100 then needs to correspond to the arrangement of the polarity of the permanent magnets included in the holders of the fasteners in order to release the pins from the receiver housings.

In some embodiments, a direction of the current provided to the electro-magnets in the fixture 1100 can be controlled to switch a polarity of the magnets in the fixture 1100. A serial number or other identifier for a particular electronic device can be read and mapped to an arrangement of the polarity of the permanent magnets included in the holders of the fasteners. The fixture 1100 can be adjusted, based on the mapping, to allow the components to be disassembled. It will be appreciated that the larger the number of fasteners, the greater the number of combinations of different arrangement of the polarity of the permanent magnets included in the holders of the fasteners.

In yet other embodiments, the magnets in the holder can be keyed using, e.g., columnated or specially serialized magnets that have a particular arrangement of magnetic polarities in an array of magnetized zones. The magnets in the fixture can then be correlated to the particular keying such that the resulting attractive force on the holder is sufficient to release the spherical components against the pin when the magnets in the fixture have a corresponding keying that matches the alignment of the keying in the holders.

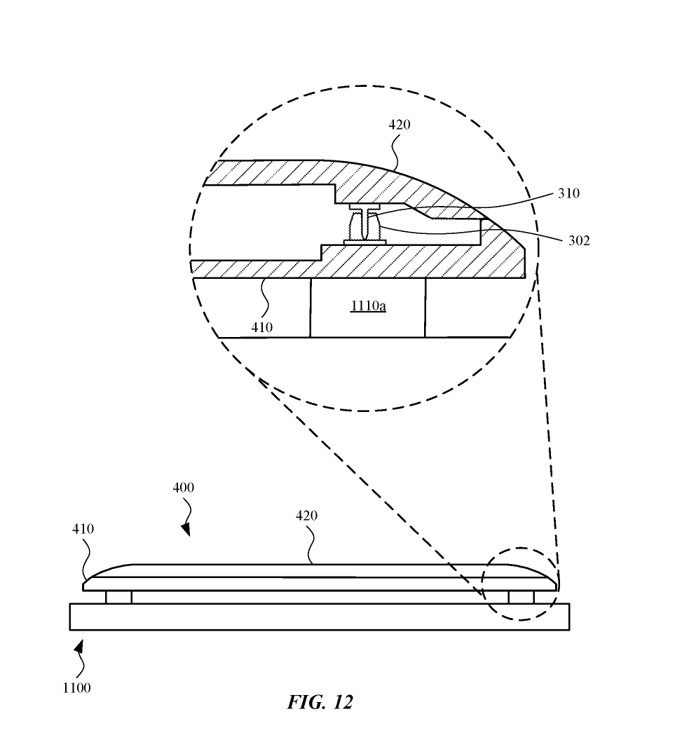

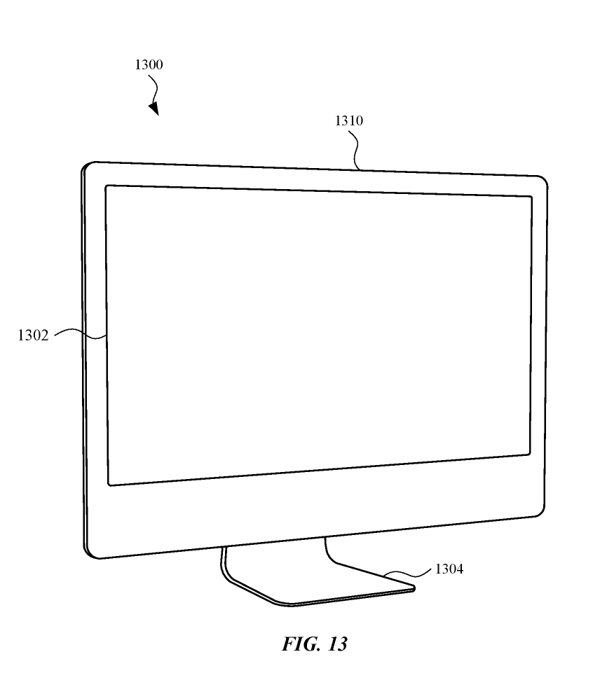

FIG. 12 shows the fixture 1100 of FIG. 11 utilized to open the enclosure of a base portion of the computing device 400, in accordance with some embodiments. As depicted in FIG. 12, the receiver housing 302 is affixed to an interior surface of the first structural component 410 and the pin 310 is affixed to an interior surface of the second structural component 420. The fixture 1100 is placed proximate an external surface of the first structural component 410, in order to generate a magnetic field by the magnet 1110a proximate the receiver housing 302. Once the fixture 1100 is in place, the second structural component 420 can be removed from the first structural component 410. In some embodiments, one or more suction cups (not shown in FIG. 12) can be attached to a rear surface of the second structural component 420 to provide a means to apply a force that is parallel to a longitudinal axis defined by the pin 310.

FIG. 13 illustrates a display device 1300, in accordance with some embodiments. The display device 1300 includes a frame 1310 surrounding a display 1302. The frame 1310 can include, e.g., an aluminum structural component overlaid by a glass substrate on the front surface of the display device 1300. The display 1302 can be, e.g., a LCD or OLED display. The glass substrate can also overlay the display 1302. The display device 1300 also includes a stand 1304, which may be formed from aluminum sheet metal.

The fasteners disclosed herein can be utilized in portable electronic devices such as laptop computers, tablet computers, mobile phones, and other wearable or hand-held devices. However, the fasteners can also be utilized within electronic devices that are not as portable such as the display device 1300, display devices traditionally coupled to a desktop computer, television devices, desktop computer chassis, speaker housings, and the like. It will be appreciated that fasteners still enable a technician to access the components within a device using specialized tools. However, most consumers may not have the fixture 1100 needed to access the components within a device. As a result, consumers may be unable to access the components within a device to swap out parts or make other repairs. Therefore, the fasteners may be most suitable for use with devices that are not intended to be opened by consumers.

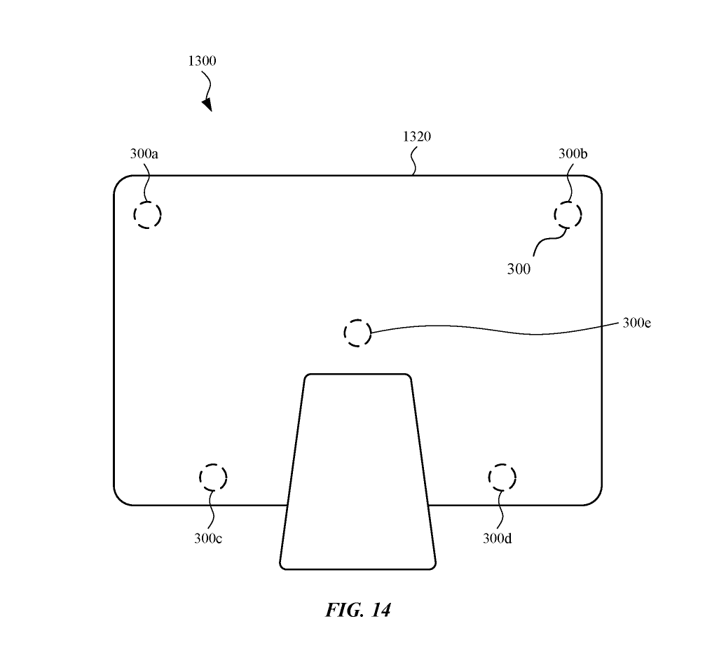

FIG. 14 shows a rear view of the display device 1300, in accordance with some embodiments. The rear view illustrates a rear cover 1320 that can be attached to a frame 1310 (not explicitly shown in FIG. 14) with one or more fasteners, such as a fastener 300a, a fastener 300b, a fastener 300c, a fastener 300d, and a fastener 300e. The aforementioned fasteners may include any features described for the fastener 300 (shown in FIGS. 3A-3C). The dashed circles shown at various locations on the surface of the rear cover 1320 illustrate five locations of fasteners disposed between an interior surface of the rear cover 1320 and a corresponding surface of the frame 1310 (shown in FIG. 13).

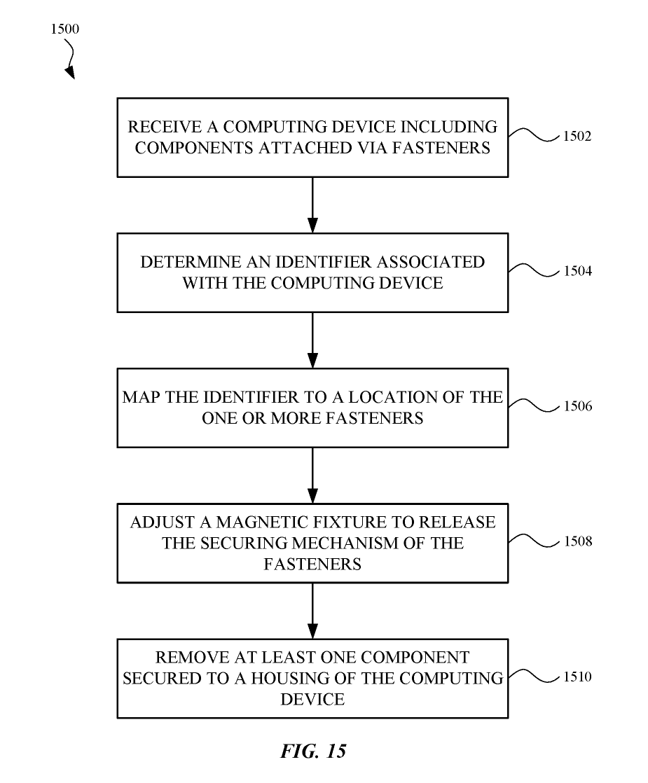

FIG. 15 illustrates a flowchart of a method 1500 to access an enclosure of a computing device secured with fasteners, in accordance with some embodiments. The method 1500 may be implemented by hardware or software, or some combination of hardware and software including, although not limited to, a processor configured to execute instructions that cause the method steps to be performed.

At step 1502, a computing device is received. The computing device includes an enclosure having at least two structural components secured via one or more fasteners. The enclosure can be, e.g., an aluminum housing that contains one or more operational components of the computing device, such as a processor, memory, battery, radio transceiver, antenna, printed circuit board, and the like. The housing can be attached to the cover by the one or more fasteners.

At step 1504, an identifier associated with the computing device is determined. In some embodiments, the identifier can be a serial number of the computing device. Alternatively, the identifier can specify a configuration or a type of the computing device.

At step 1506, the identifier is mapped to a location of each fastener of the one or more fasteners included within the enclosure of the computing device. The identifier may also be mapped to a magnetic polarity of a magnet(s) of each fastener of the one or more fasteners. In some embodiments, the locations of the fastener(s) can be changed based on the identifier. In other embodiments, the polarity of a permanent magnet included in each fastener can be configured as either oriented with a North Pole or a South Pole facing an external surface of the enclosure.

At step 1508, a magnetic fixture is adjusted to release the securing mechanism of the fasteners based on the locations and/or polarities of the fasteners. In some embodiments, actuators are utilized to move the magnets to the locations specified by the mapping. In other embodiments, a controller switches the direction of current applied to electro-magnets embedded or otherwise included within the fixture to change an orientation of the magnetic field generated by the fixture. Once adjusted, the magnetic fixture is placed proximate an external surface of the computing device.

At step 1510, at least one component secured to the housing by the fasteners is removed from the computing device. In some embodiments, the magnetic field generated by a magnet of the fixture pulls the spherical components away from a top surface of a receiver housing included in the fasteners. This releases the pins of the fasteners, enabling the component to be removed by extracting the pins from the openings in the receiver housings.

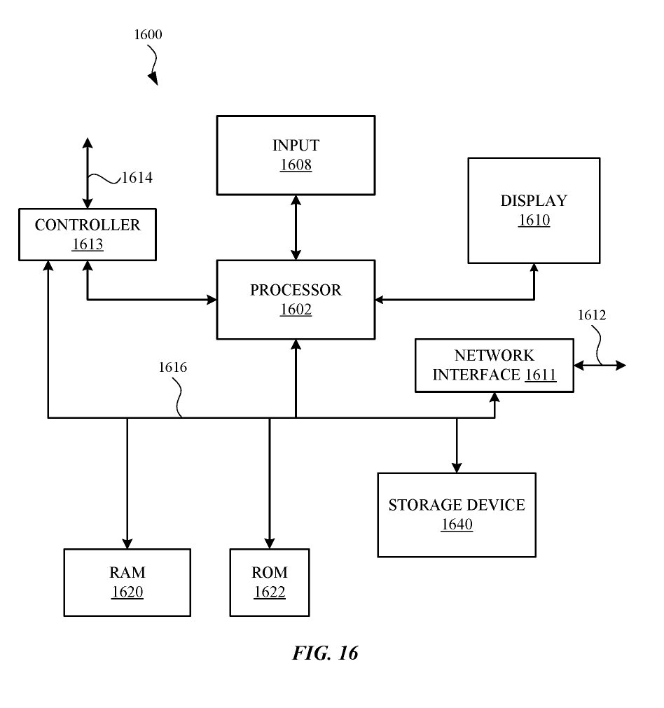

FIG. 16 illustrates a detailed view of a computing device 1600 that can be used to implement the various apparatus and/or methods described herein, in accordance with some embodiments. In particular, the detailed view illustrates various components that can be included in the computing devices illustrated and/or described herein. For example, the computing device 100, computing device 400, display device 1300, or any other device may be implemented, at least in part, to include the components of the computing device 1600. In addition, a control system for implementing the adjusting of the fixture 1100 as described in step 1508 of the method 1500 (shown in FIG. 15), can include a controller that includes one or more components of computing device 1600.

As depicted in FIG. 16, the computing device 1600 can include a processor 1602 that represents a microprocessor or controller for controlling the overall operation of computing device 1600. The computing device 1600 can also include a user input device 1608 that allows a user of the computing device 1600 to interact with the computing device 1600. For example, the user input device 1608 can take a variety of forms, such as a button, keypad, dial, touch screen, audio input interface, visual/image capture input interface, input in the form of sensor data, etc. Still further, the computing device 1600 can include a display 1610 (screen display) that can be controlled by the processor 1602 to present visual information to the user. A data bus 1616 can facilitate data transfer between at least a storage device 1640, the processor 1602, and a controller 1613. The controller 1613 can be used to interface with and control different equipment through an equipment control bus 1614. The computing device 1600 can also include a network/bus interface 1611 that couples to a data link 1612. In the case of a wireless connection, the network/bus interface 1611 can include a wireless transceiver.

The computing device 1600 also include a storage device 1640, which can comprise a single disk or a plurality of disks (e.g., hard drives), and includes a storage management module that manages one or more partitions within the storage device 1640. In some embodiments, storage device 1640 can include flash memory, semiconductor (solid state) memory or the like. The computing device 1600 can also include a Random Access Memory (RAM) 1620 and a Read-Only Memory (ROM) 1622. The ROM 1622 can store programs, utilities or processes to be executed in a non-volatile manner. The RAM 1620 can provide volatile data storage, and stores instructions related to the operation of the computing device 1600.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A portable electronic device, comprising:
a top portion;
a base portion attached to the top portion via a hinge, the base portion comprising a keyboard and housing that includes a cavity formed therein, the cavity covered by the keyboard;
operational components disposed in the cavity and attached to the housing; and
a cover secured to the housing via a fastener to enclose the cavity, the fastener comprising:
a receiver housing having a surface that includes an opening,
spherical components enclosed within the receiver housing,
a biasing module that biases the spherical components toward the; and
a pin configured to be inserted into the opening such that the spherical components are in contact with the pin and an inner surface of the receiver housing that is sloped toward the opening.

2. The portable electronic device of claim 1, wherein the opening in the surface of the receiver housing is chamfered.

3. The portable electronic device of claim 1, wherein the fastener is enclosed within the cavity when the cover is attached to the housing and not visible through an external surface of the cover.

4. The portable electronic device of claim 1, wherein the pin is attached to the housing via a pin holder that facilitates replacement of the pin, the pin holder permanently attached to the housing.

5. The portable electronic device of claim 1, wherein the cover is secured to the housing via at least two fasteners.

6. The portable electronic device of claim 1, wherein the operational components include:
a memory storing instructions; and
a processor in communication with the memory and configured to execute the instructions.

7. The portable electronic device of claim 1, wherein the biasing module comprises a wave spring.

8. The portable electronic device of claim 1, wherein the biasing module comprises a stack of Belleville washers.

9. The portable electronic device of claim 1, wherein the spherical components are ferromagnetic such that, under an influence of a magnetic field generated by a magnetic element placed proximate a side of the fastener opposite the opening, the spherical components experience an attractive force due to the magnetic field, thereby causing the spherical components to compress the biasing module and directing the spherical away from the opening.

10. An apparatus including a housing for a keyboard, the apparatus comprising:
a first structural component that defines a cavity;
a second structural component configured to be secured to the first component;
a pin attached to a surface of either the first structural component or the second structural component; and
a receiver housing attached to a surface of either the second structural component or the first structural component such that the pin and the receiver housing are attached to different components of the first structural component and the second structural component,
wherein a surface of the receiver housing includes an opening having a diameter that is greater than a diameter of the pin, the receiver housing retaining spherical components that are biased against a sloped surface of the receiver housing and a surface of the pin when the pin is inserted into the opening.

11. The apparatus of claim 10, wherein the spherical components are retracted away from the sloped surface of the receiver housing under an influence of a magnetic field to reduce a force imparted by the spherical components against the pin.

12. The apparatus of claim 10, wherein the receiver housing retains three spherical components configured to surround the pin.

13. The apparatus of claim 10, wherein the receiver housing retains four or more spherical components configured to surround the pin.

14. The apparatus of claim 10, wherein the spherical components are retained within a holder configured to equally space the spherical components around a perimeter of the pin.

15. A laptop computer, comprising:
a top portion including a display;
a base portion coupled to the top portion via a hinge, the base portion comprising:
an aluminum housing that encloses a processor and a memory attached to a printed circuit board, the printed circuit board attached to the aluminum housing;
a cover that overlays an opening in the aluminum housing; and
a fastener that secures the cover to the aluminum housing, the fastener comprising:
a structure having a first surface that includes an opening and a second surface attached to the aluminum housing; and
a pin having a size and shape capable of insertion into the opening of the structure,
wherein the pin is retained within the structure by a force applied to a surface of the pin by spherical components retained within the structure and arranged to contact the surface of the pin and an inner surface of the structure sloped towards the opening.

16. The laptop computer of claim 15, wherein the pin includes a flange attached to the cover.

17. The laptop computer of claim 15, wherein the force is a frictional force proportional to a normal force imparted by the spherical components biased against the surface of the pin and the inner surface of the structure.

18. The laptop computer of claim 15, wherein the spherical components are biased against the surface of the pin and the inner surface of the structure by a biasing module enclosed within the structure.

19. The laptop computer of claim 15, wherein the spherical components are retained within a holder having a number of holes formed therein, each hole having a size and shape to retain a particular spherical component spaced evenly around a center of the holder.

20. The laptop computer of claim 15, wherein the pin includes a detent feature, at least one spherical component held against the detent feature by a ferromagnetic release mechanism biased toward the first surface of the structure.
